(19) United States
(12) Patent Application Publication
(10) Pub. No.: US 2014/0145447 A1
(43) Pub. Date: May 29, 2014

(54) Windmill, Rotor Blade and Method

(71) Applicant: Marinus Mieremet, Vinkeveen (NL)

(72) Inventor: Marinus Mieremet, Vinkeveen (NL)

(73) Assignee: De Archimedes B.V., Rotterdam (NL)

(21) Appl. No.: 13/697,704

(22) PCT Filed: May 10, 2010
(86) PCT No.: PCT/NL2010/050266

§ 371 Date: Mar. 15, 2013

(51) Int. Cl. F03D 1/06; F03D 9/00

(52) U.S. Cl. CPC F03D 1/0608; F03D 9/002
USPC 290/55; 416/176

(57) ABSTRACT

The invention relates to a rotating machine for interaction with a fluid medium, comprising a rotor with one or more blades with which energy is extracted from or relinquished to the medium. The blade extends helically or spirally along the rotor axis. The projection of the blade forms in the flat plane a continuously narrowing strip spiralling around a centre point. The blade is preferably membrane-like. As seen in side view the blade has a cone-shaped end situated on the downstream side of the fluid medium.

The present invention relates to a rotor blade unit. The invention further relates to a fluid interaction device.

Many different types of wind turbines are known. Each of these wind turbines has its own operating principle with specific advantages. The present invention provides a different operating principle with specific advantages not available in the prior art.

From the international patent publication with publication number WO 2008/060147 in the name of the same applicant as the present application, a windmill is known comprising a basic version of aspects of the present invention. Objects of the present invention are to provide a number of improvements with regard to this document.

The present invention provides for this purpose a rotor blade unit, comprising at least a rotor blade or vane for realizing an energy conversion with a fluid medium, wherein the form of a rotor blade comprises the following characteristics that:
it is spiral-shaped around a central axis,
the blade extends substantially along the central axis from the central axis, and the blade is definable in a flat plane from which it can be transformed into the three-dimensional spiral shape.

An advantage of such a rotor blade unit is that an interaction with a medium is provided wherein an energy transfer is possible in a manner which hardly disrupts the fluid flow. A suction action is for instance provided with this rotor blade unit whereby the efficiency per area is relatively high. This suction action enables an operation wherein the efficiency is maintained even at an angle with the fluid flow. The rotor blade unit is further able to orient itself automatically, even without a wind vane.

A first preferred embodiment comprises a windmill according to the present invention:
a stand for mounting the windmill on a surface,
rotation means for rotatably mounting the stand with regard to the rotor blade,
a generator assembly for converting kinetic energy to electrical energy. By means of this embodiment, a practical embodiment is provided for providing a structure using the present rotor blade.

According to a further preference, such a windmill according to the present invention comprises at least a connection arm for connecting the front end or the back of the rotor blade with the base. Because of this, a practical way of providing a reinforcement is enabled. Such a reinforcement prevents and or diminishes undesirable vibrations and provides more firmness to the combination of rotor blade and the rest of the windmill.

According to a further preferred embodiment, the rotor blade is formed by means of injection molding. Because of this, a rotor blade can be mass produced in a economical way, which is especially advantageous with a relatively small number of versions. Windmills are envisaged in formats from several decimetres to several dozens of meters.

In a further preferred embodiment, the windmill comprises a central rotor blade axel. One of the main advantages thereof is that firmness can be provided to the rotor blade over a substantial length of the depth of the rotor blade for providing intrinsic firmness.

According to a further preference, the rotor blade comprises a central support body for arranging with regard to the central rotor blade axel. This central support body can provide a contribution to the firmness of the rotor blade and can be produced in one part with rotor blade during production thereof. It is however also possible that after, the spiral shaped part of the rotor blade is produced, this is subsequently connected with the central support body upon assembling of the rotor blade.

In several preferred embodiments, the rotor blade extends π times around the central axis. Because of this an efficient rotor blade is provided. The advantages are explained in greater detail in the remainder of this text referring to the drawings.

For providing a generation function for electrical energy according to the present invention, the windmill comprises a ring shaped generator, comprising:
a number of fixed magnets arranged in a substantially ring shaped array for providing an alternating magnetic field,
a number of coils concentrically arranged with respect to the ring shaped array of fixed magnets for generating the electrical energy.

Advantageously the coils are arranged around coil cores.

With a further preference, in such a windmill, the coil cores are C shaped, the windings preferentially wound around the back of the C, and with further preference, the legs of the C directed at the fixed magnets.

By means of such preferred embodiments, electrical energy is provided in an efficient manner and especially a generation assembly that is economically producible.

According to a further preference, switching means are provided for variably switching a number of coils. Because of this, the windmill can be used with relatively low winds speeds and with relatively high wind speeds, whereby the power and the resistance can be varied.

In a further preferred embodiment, the rotor blade is produced with composite materials. Because of this, it is possible to provide a layered structure of the material with an inherent firmness. It is found that such a production method is especially advantageous with the spiral shape.

According to a further preference, the windmill comprises a drive mechanism for forcibly rotating the windmill with respect to the base. A drive mechanism in this sense is defined as a mechanism for rotating the windmill with regard to the base. Because of the properties of the rotor blade, the windmill is oriented automatically with respect to the wind within certain limits. Because of this, the practical advantage of the drive mechanism is that it is possible to direct the windmill substantially more than 90 degrees from the wind.

According to a further preferred embodiment, each rotor blade is substantially definable within a circular shape by means of defining a curve within the circle, which curve extends from substantially the centre of the circle to the edge of the circle, and a straight line extending radiantly from the centre to substantially a meeting point of the curve with the edge of the circle, by means of which the circle is divided in a rotor blade surface and excision surface. An advantage thereof is a further improvement of the set effects.

According to a further preference, the ratio between the rotor blade and the excision surface is substantially two to one. Because of this, three rotor blades provide the surface of half a sphere which is a maximum ratio of a volume that the fluid ca receive with regard to a surface to convert energy.

According to a further preference, each rotor blade is shaped like a membrane, sheet of plate. Because of this, a large surface is possible with regard to the volume used that is provided by the rotor blade.

A further aspect according to the present invention provides a rotor blade according to the present invention, for application in a device according to the invention.

A further aspect according to the present invention provides a method for generating energy by means of a device according to the present invention, the method comprising steps for:
providing the device,
leaving the device to interact with a fluid,
leading away the obtained electrical energy.

According to a further preferred embodiment, the rotor blade comprises a number, preferably three, rotor blades that are mutually arranged along a common axis with an equal mutual angular spacing with regard to the heart line in which the rotor blades are assembled in a way that spiral in an intertwined fashion. Because of this, with one volume of the rotor blade, a larger yield can be achieved. A further advantage is that a larger stability can be achieved because the pressure of the fluid is exerted more equally over the blades of the rotor blade unit.

Further advantages, features and details of the present invention will be described in greater detail hereinbelow with reference to several preferred embodiments. Reference is made here to the accompanying figures, in which:

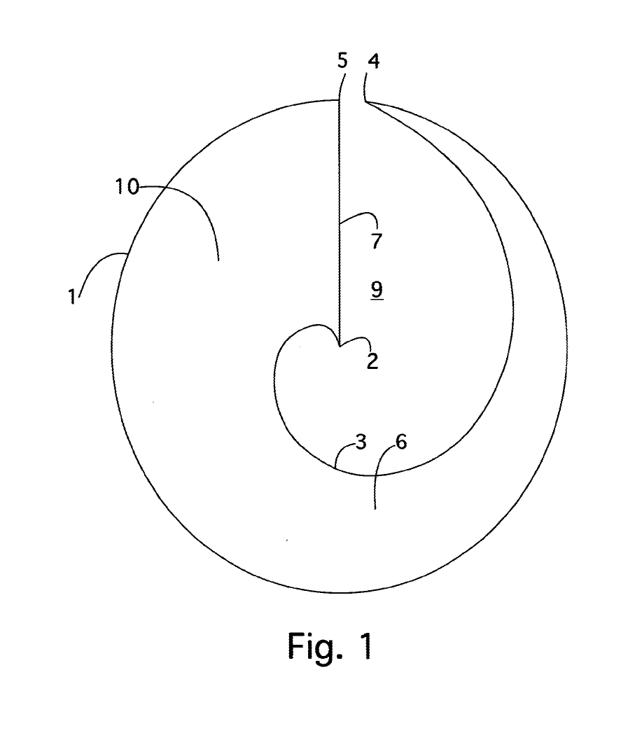

FIG. 1 is a view of a first preferred embodiment according to the present invention;

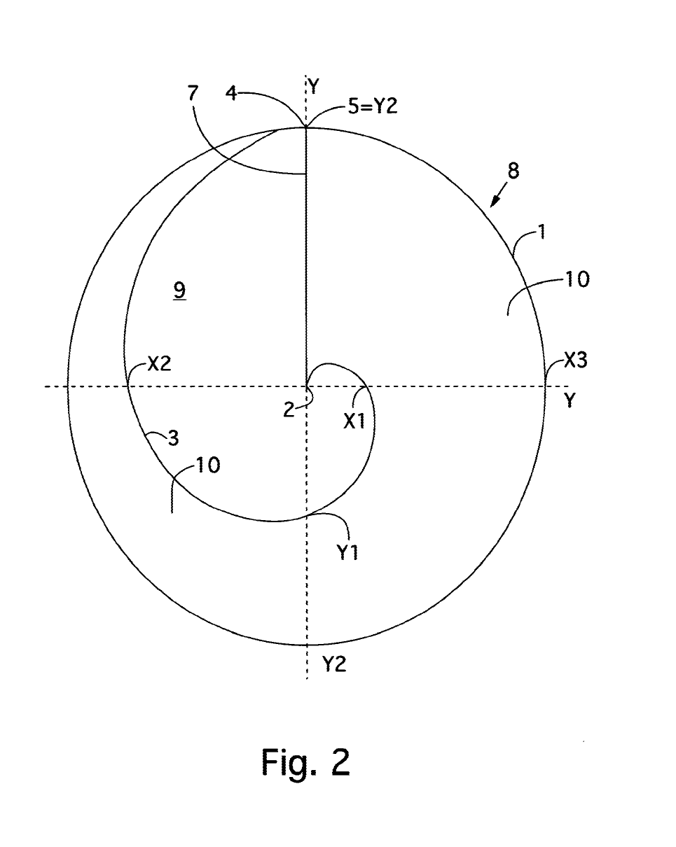

FIG. 2 is a view of the preferred embodiment similar to FIG. 1, with indicator lines;

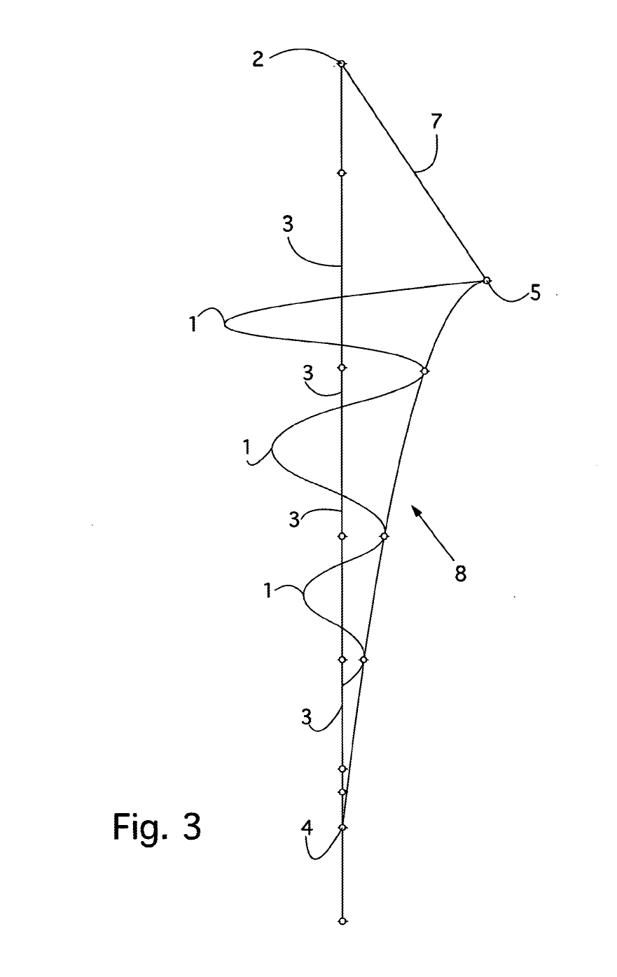

FIG. 3 is a schematic side view of the embodiment of FIG. 2 in a position of use;

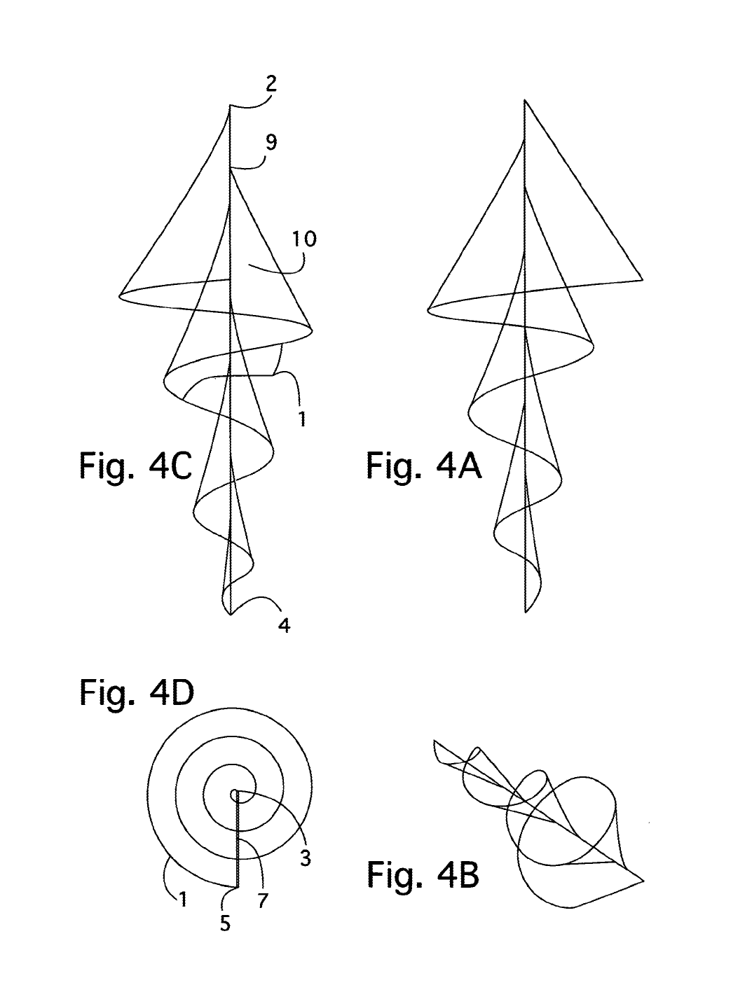

FIGS. 4A-D are different views of the embodiment of FIG. 2;

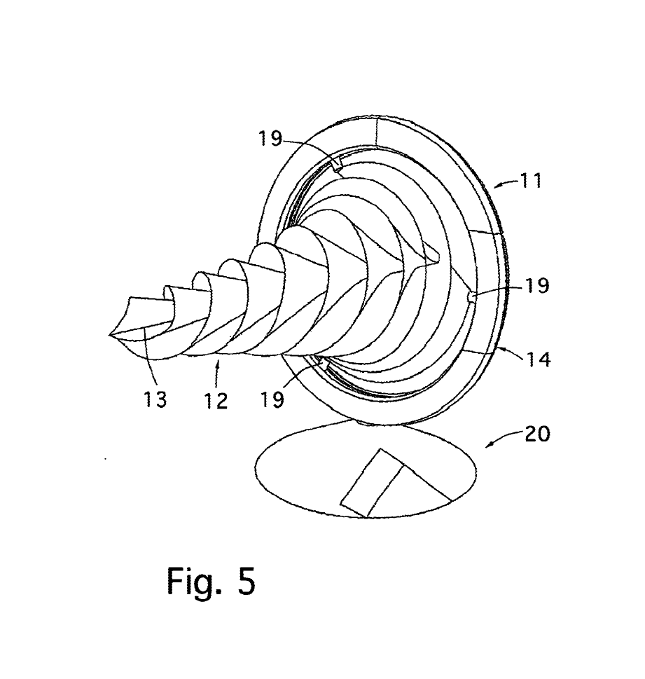

FIG. 5 is a perspective view of a further preferred embodiment according to the present invention;

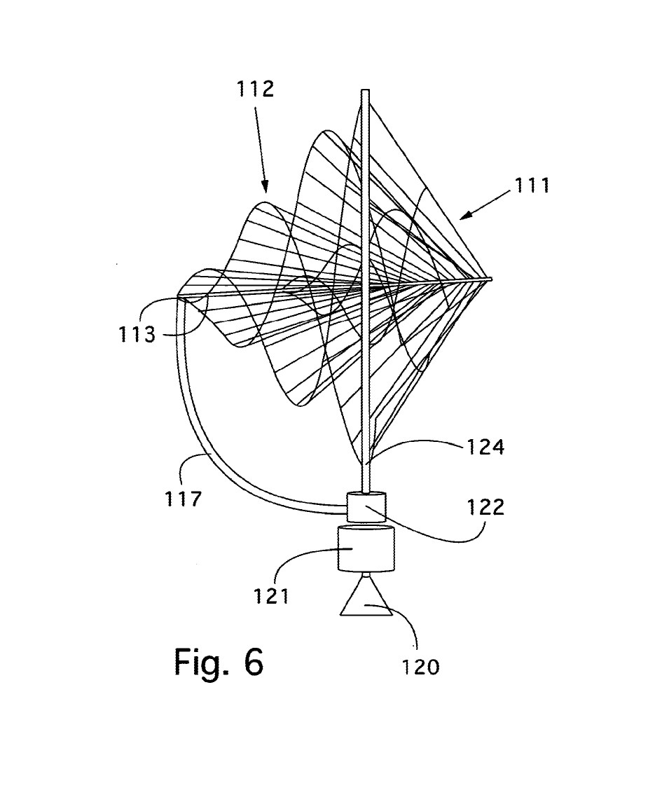

FIG. 6 is an exploded view in side view, of a further preferred embodiment according to the present invention;

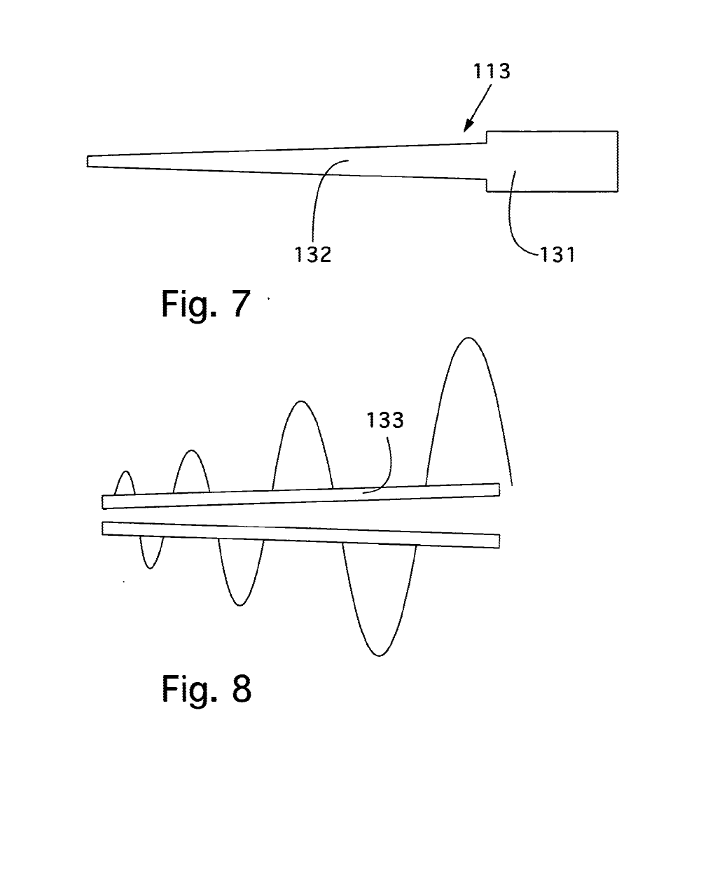

FIG. 7 is a representation in side view of a further preferred embodiment;

FIG. 8 is a representation of a further preferred embodiment;

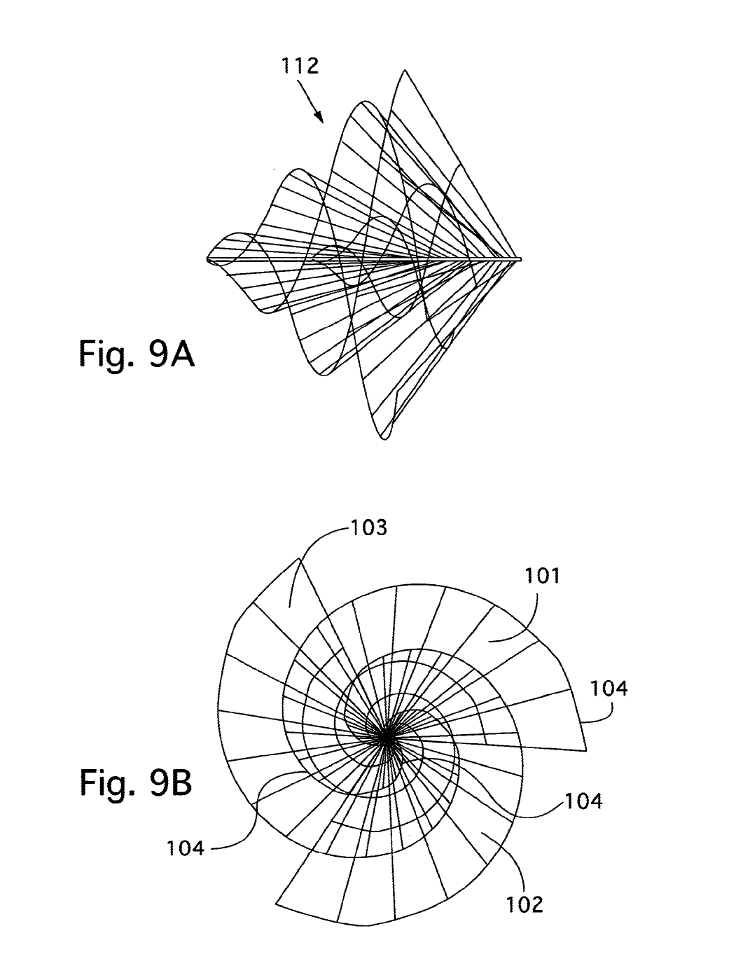

FIG. 9A, DR representations in side view and front view of a of a rotation blade for the preferred embodiment of FIG. 6;

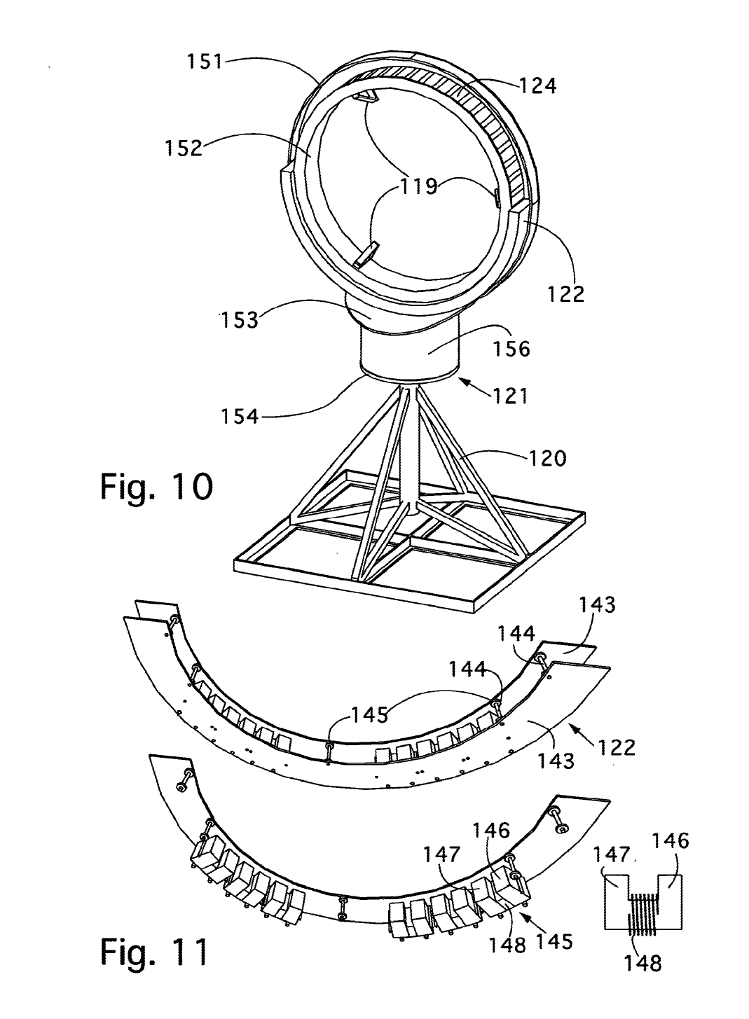

FIG. 10 is an isometric exploded view of the preferred embodiment of FIG. 6;

FIG. 11 is an isometric exploded view of a detail of FIG. 10;

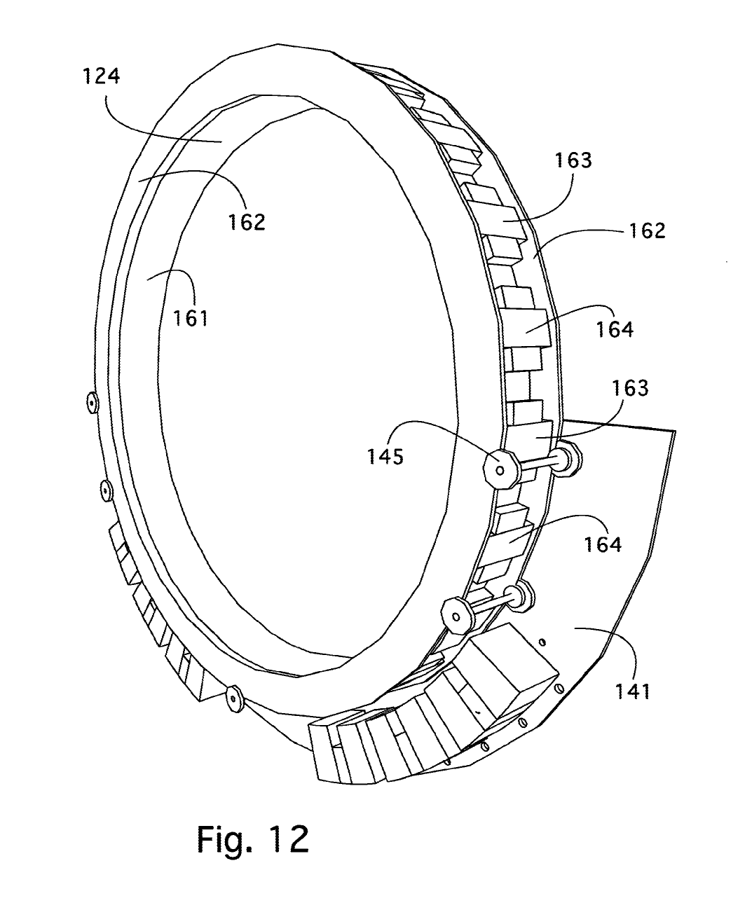

FIG. 12 is an exploded view of a schematic representation according to FIG. 10.

A first preferred embodiment according to the present invention (FIG. 1) relates to a top view of a representation of a blade according to a first preferred embodiment according to the present invention. This is a blade definable on a plane which forms a curved surface in the position of use, wherein line 3 substantially forms a straight line around which the curved surface formed by sheet 10 extends. The outside line 1 here circles round “axis” 3 several times. FIG. 2 shows a representation of a further preferred embodiment of this blade definition, wherein several intersections of lines indicating dimensions are defined. In this preferred embodiment blade surface 10 is drawn round a coordinate system x,y. Curved line 3 extends in upward direction from the origin, curves downward to intersect the x-axis at a distance xl, which is ¼ the distance x3, wherein x3 is the circumference of the circle formed by curve 1. Curve 3 intersects the y-axis at intersection y1, which is half the distance to the origin, and intersection y2 with circle 1. Curve 3 further intersects the x-axis at intersection x2, which, from the origin, is removed ¾ of the distance x3 relative to the origin. Finally, curve 3 intersects the y-axis at point y2, which is just as far from the origin as point y. This almost mathematical representation of the area of the vane blade in the flat plane can of course only be approximated in practice. According to this preferred embodiment the vane blade will thus have substantially this form, but will differ to the extent this is necessary from a production engineering viewpoint. Although this definition of the curve is only an example and this definition does not fully determine the curve, it is possible within the concept of the present invention that other curves exist which define a vane blade within the circle of curve 1, with an operation which falls within the present invention.

In the view of FIG. 2 straight lines are further drawn which are designated by means of Roman numerals I, II, III, IV. The curves are shown in the schematic side view of FIG. 3 in order to further elucidate the spatial orientation in the position of use. Edges 1, 3 and 7 are also shown in this FIG. 3 in order to indicate the position of these edges in the spatial form. Origin 2 is further shown as the outermost end of the blade in the spatial orientation. The other outermost point 4 is situated at the other end. Line 1 runs from point 2 to point 4. Line 7 runs from point 2 to point 5 and line 3 runs from point 2 to point 4, this as also shown in the flat plane. For the purpose of elucidating the construction of a vane blade, it is shown in four different orientations in FIGS. 4A-4D. FIG. 4A relates to a side view, as does FIG. 4C. The difference here is a 90° rotation around the longitudinal axis of the vane blade. FIG. 4B shows a perspective view of the vane blade. FIG. 4D shows a front view. Clearly shown here is how in this preferred embodiment the number of rotations of the vane blade around central axis 3 is slightly greater than 3. In a determined preferred embodiment the number of rotations of the vane blade round the central axis amounts to pi revolutions.

FIG. 5 shows an example of an embodiment in which a vane blade as described in the foregoing is incorporated in a wind turbine. Three of these vane blades are incorporated into this wind turbine 11, each of which are rotated 120° relative to central axis 13, which is formed by three of the edges 3 of each of the blades, for the purpose of arrangement at an equal angular distance. The wind turbine is constructed round a rotor 12 which is arranged rotatably inside an outer ring 14. Forming part of the rotor is an inner ring 15 which is connected to rotor blades 16, 17 and 18 by means of fixing rods 19. The outer ring is mounted on a stand which can be constructed in many different ways. The stand serves for mounting of the whole on the ground or a building. The outer ring is mounted rotatably relative to the stand in a manner which is not shown. The skilled person will be able to propose a variety of bearing mountings for this purpose.

FIG. 6 shows a further preferred embodiment of a wind turbine 111 according to the present invention. Wind turbine 111 comprises a base 120 connected to a firm ground surface. A rotation unit 121 is disposed on base 120. The upper side of the rotation unit is arranged rotatably relative to the base. A ring 122 (shown in section) for holding the stator of the wind turbine is arranged on the rotation unit. A rotor ring 124 is disposed in stator ring 122. A unit of three rotor blades 112 is arranged inside the rotor ring. The unit of three rotor blades 112 is mounted round a central rotor blade shaft 113. The front part of rotor blade shaft 113 is bearing-mounted on the top side of a support body 117 for the purpose of connecting the rotor blade shaft to rotation unit 121.

FIGS. 7 and 8 show a preferred embodiment of rotor blade shaft 113 comprising a base 131 and a shaft part 132 which tapers to some extent. A central support body 133 of the unit of three rotor blades is formed for close fitting relative to shaft part 132. A good attachment is hereby obtained between the central shaft and the rotor blade unit.

Rotor blade unit 112 is shown in greater detail in FIG. 9. At the position where rotor blade unit 12 was wound n times round the central shaft, the rotor blade unit 112 has a winding round the central axis. The length of the rotor blade unit can hereby remain limited. In the view of FIG. 9B the single spiral can be discerned by following line 104 of blade 101. This line begins at the outermost point of blade 101 and ends at the central axis after running in a 360° spiral round this central axis.

The aspect of the generator is shown in greater detail in FIGS. 10-12. The wind turbine is placed on base 120. Rotation unit 121 comprises a slide bearing 154 with a bush 156 mounted thereon for free rotation. Attached to bush 156 is a saddle support for mounting thereon of the outer side of the underside of stator ring 122. Rotor ring 124 is arranged inside stator ring 122. For the purpose of protecting the stator ring on the rotor ring two dust covers are arranged, 151 for the outer side and 152 for the inner side.

Stator ring 122 is shown in greater detail in FIG. 11. The stator ring is constructed from two printed circuit boards 143 mutually connected by means of shafts 144. Guide wheels for supporting the rotor ring are arranged on shafts 144. The stator ring comprises a plurality of stator units 145. Each stator unit is constructed from a C-shaped steel core comprising two outer ends 146, 147 adapted in the direction of the rotor.

Arranged in each case around the spine part of the C is a winding for the purpose of generating the electric current on the basis of a variable magnetic field. The variable magnetic field is of course generated by the magnets moving by during operation. The stator units are for instance manufactured from iron or ferrite.

Rotor ring 124 comprises a wheel part of substantially U-shaped section with a bottom 161 and two side walls 162. In this ring are permanent magnets with an alternating south pole 163 or north pole 164.

The present invention is described in the foregoing on the basis of several preferred embodiments. Different aspects of different embodiments are deemed described in combination with each other, wherein all combinations which can be made by a skilled person on the basis of this document should be included. These preferred embodiments are not limitative for the scope of protection of this text. The rights sought are defined in the appended claims.

1. A wind turbine, comprising a rotor blade unit comprising at least a rotor blade or vane for realizing an energy conversion with a fluid medium, wherein the
(a) is spiral-shaped around a central axis,
(b) extends substantially along the central axis from the central axis, and
(c) is definable in a flat plane from which it can be transformed into the three-dimensional spiral shape.

2. The wind turbine as claimed in claim 1, further comprising:
a base for placing the wind turbine on a ground surface,
rotation means for arranging the rotor blade rotatably relative to the base, and
a generator assembly for converting kinetic energy to electric energy.

3. The wind turbine as claimed in claim 1, further comprising at least a connecting arm for connecting the front sides and/or the rear side of the rotor blade to the base.

4. The wind turbine as claimed in claim 1, wherein the rotor blade is formed by means of injection moulding.

5. The wind turbine as claimed in claim 1, further comprising a central rotor blade shaft.

6. The wind turbine as claimed in claim 5, wherein the rotor blade comprises a central support body for arranging relative to the central rotor blade shaft.

7. The wind turbine as claimed in claim 1, wherein the rotor blade extends 1-n times round the central axis.

8. The wind turbine as claimed in claim 1, further comprising an annular generator comprising:
fixed magnets arranged in an annular array for providing an alternating magnetic field, and
an annular array of coils arranged concentrically relative to the annular array of arranged fixed magnets for the purpose of generating the electric energy.

9. The wind turbine as claimed in claim 8, wherein the coils are arranged round coil cores.

10. The wind turbine as claimed in claim 9, wherein the coil cores are C-shaped, and the windings are
preferably wound round the spine of the C, and the legs of the C are more preferably directed toward the fixed magnets.

11. The wind turbine as claimed in claim 8, further comprising switching means for variable switching of a number of coils.

12. The wind turbine as claimed in claim 1, wherein the rotor blade is manufactured from composite materials.

13. The wind turbine as claimed in claim 1, further comprising a drive mechanism for forced rotation of the turbine relative to the base.

14. The wind turbine as claimed in claim 1, wherein each rotor blade is substantially definable within a circular form by means of defining a curve inside the circle which extends from substantially the centre of the circle to the edge of the circle, and a straight line which extends as a radial from the centre to substantially the intersection of the curve and the circumference, and wherein the circle is divided into a rotor blade area and a cut-away area.

15. The wind turbine as claimed in claim 1, wherein the ratio between the rotor area and the cut-away area is about two to one.

16. The wind turbine as claimed in claim 1, wherein each rotor blade is membrane, sheet or plate-like.

17. (canceled)

18. A method for obtaining energy by means of the device as claimed in claim 1, comprising steps for:
providing the device,
allowing the device to interact with a fluid, and
taking off the obtained electric energy.
